(19) United States
(12) Patent Application Publication
(10) Pub. No.: US 2003/0018586 A1
(43) Pub. Date: Jan. 23, 2003

(54) Prepaid internet CD package

(76) Inventor: Gerald C. Krahn, Brush Prairie, WA (US)

Correspondence Address: Michael F. Scalise, Hodgson Russ LLP, Suite 2000, One M&T Plaza, Buffalo, NY, 14203-2391, US

(21) Appl. No.: 09/907,048

(22) Filed: Jul. 17, 2001

(51) Int. Cl. G06F 17/60

(52) U.S. Cl. 705/58; 206/461; 206/308.1; 206/459.5

(57) ABSTRACT

The present invention relates to a retail sale package consisting of an envelope card containing a compact disc. The compact disc has a selectively activatable device for activating the compact disc. Once activated, the compact disc is used in conjunction with the internet to access a web site for browsing and to download music or other desired electronic files onto a separate data storage device. Payment for the internet access is typically the cost of purchasing the package.

### BACKGROUND OF THE INVENTION

1. Field of the Invention

The current invention relates to a package comprising an envelope card containing a compact disc (CD) programmed to route a user to a chosen web site on the internet. The user pays a suggested retail price for the envelope card. The compact disc is activated at the time of purchase, or in a batch of envelope cards at the time they are shipped from the manufacture to the retailer.

The user is then able to access the internet by loading the compact disc into a network computer. Once on the internet, the user can download files, such as of music and other information, from a web site. The unit of measured access may vary by opportunity, by minutes on the internet, or by digital downloads. For example, when the measure is digital downloads, the user may be on the internet as long as they want, but as files are downloaded, an accounting is done between files downloaded and the number of files prepaid. The files are downloaded to the user's hard drive or other storage device or media, then sent to any one of a number of output devices, such as CD burners, diskettes, tape, MP3 players and others.

2. Prior Art

There has been a need to develop a system whereby a person can access the internet using a prepaid compact disc and, if desired, download music or other electronic files from a web site. Heretofore, the prior art has described various compact disc package assemblies. Some of these include those described in U.S. Pat. Nos. 5,048,681 to Herkel, 5,842,629 to Sprague and 6,109,439 to Goade. However, the compact discs of these patents are not prepaid to gain access to data files on the internet.

Thus, there is a need for a package containing a compact disc which is selectively activated and then used in conjunction with the internet to access a web site. If desired, the user is then able to download music and/or other electronic files onto a data storage device. Preferably, payment for the internet access is at the time of receiving the package from a retail store.

### SUMMARY OF THE INVENTION

The package of the present invention consists of an envelope card having a compact disc contained therein. A magnetic strip and/or a bar code on the compact disc is viewable from outside the package and is selectively activated either at the manufacture or at the time of purchase. In the former case, a batch of the activated envelope cards is shipped from the manufacturer to the retailer, and the retailer must confirm receipt of the batch to maintain the compact discs activated. Activation of the compact disc activates a PIN embedded in the CD. The compact disc is then used in conjunction with the internet to access a web site and, if desired, download music or other desired electronic files onto a separate data storage device.

### BRIEF DESCRIPTION OF THE DRAWINGS

FIG. 1 is a plan view of the package of the present invention containing a compact disc.

FIG. 2 is a cross-sectional view along line 2-2 of FIG. 1.

FIG. 3 is a cross-sectional view along line 3-3 of FIG. 1.

FIG. 4 is a plan view of the package in an opened condition with the compact disc being removed.

FIG. 5 is a plan view of the back of the package.

### DETAILED DESCRIPTION OF THE PREFERRED EMBODIMENTS

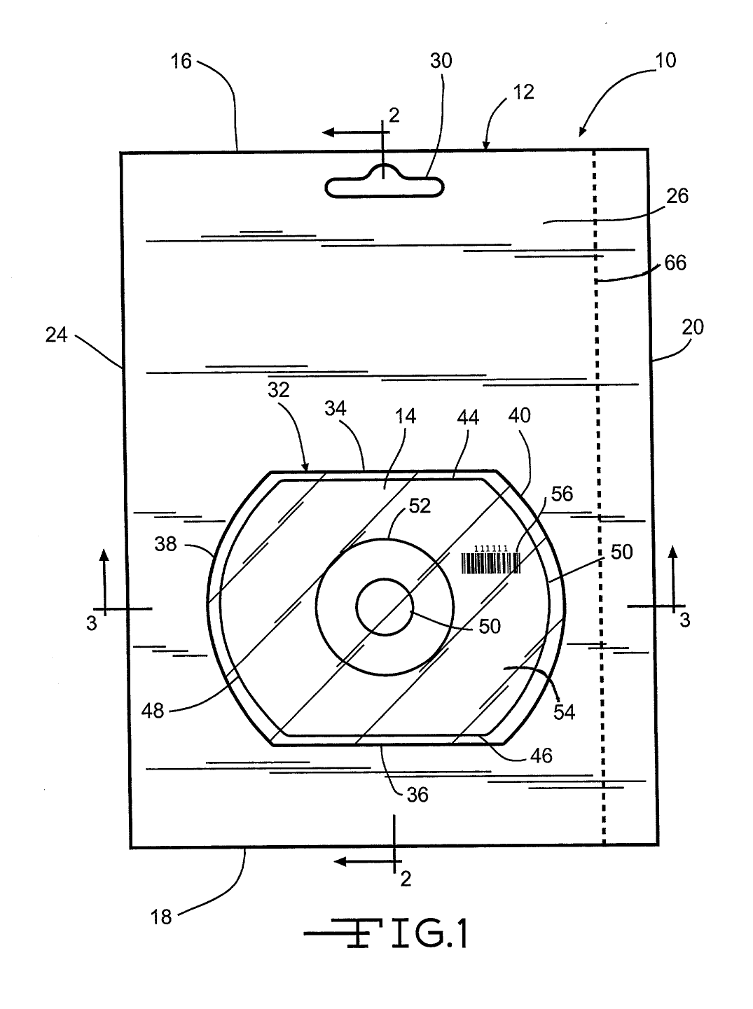

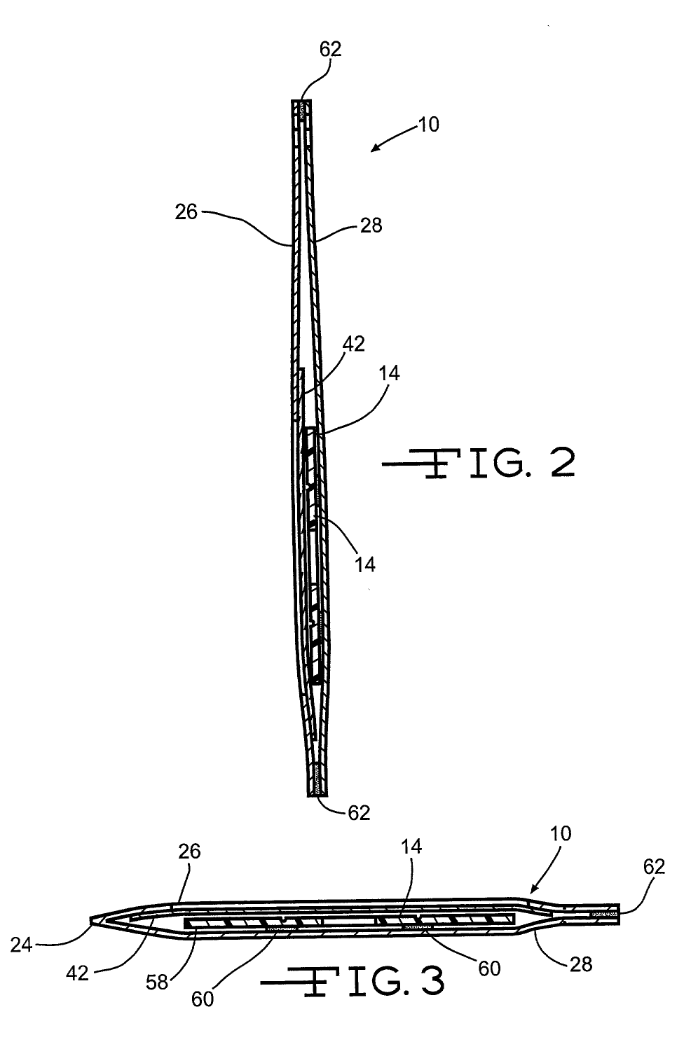

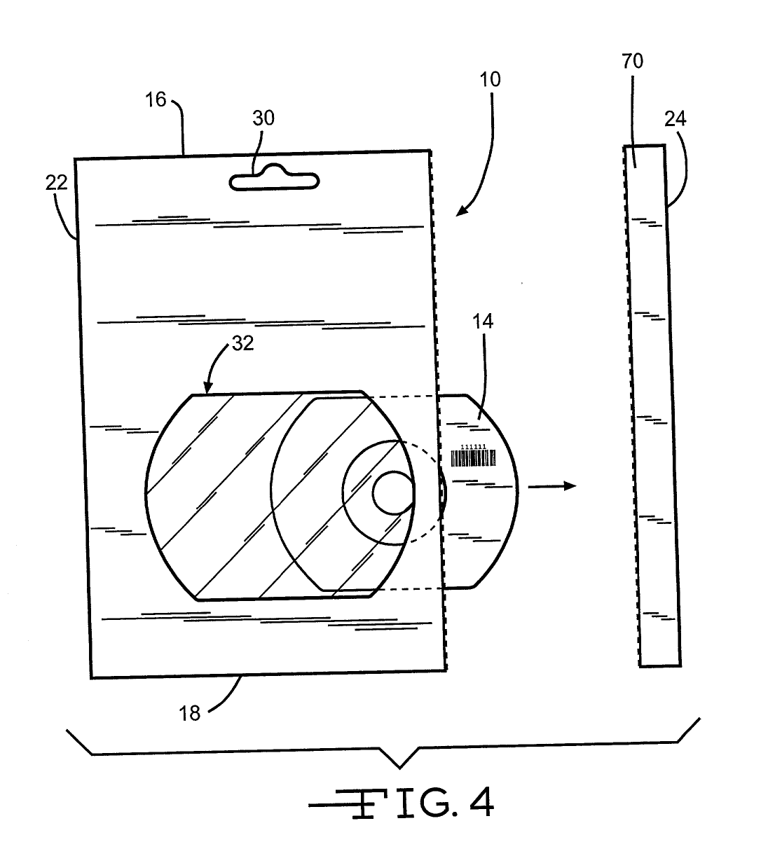

Turning now to the drawings, FIGS. 1 through 5 show a preferred embodiment of a prepaid internet CD package 10 according to the present invention. The package 10 generally comprises an envelope card 12 containing a compact disc 14. The envelope 12 is made of a single sheet of card stock of a suitable grade which is twice as long as that shown in either FIGS. 1 or 5. As shown with respect to those two figures, the unfolded card stock has spaced apart upper and lower edges 16 and 18 extending to and meeting with first and second ends 20 and 22. The envelope 12 is formed when the card stock is folded along a line bisecting the upper and lower edges 16, 18 such that the first and second ends 20, 22 coincide. This provides a fold edge 24 opposite the coinciding first and second ends 20, 22. In that respect, the envelope 12 has a face panel 26 (FIG. 1) bordered by the upper and lower edges 16, 18 extending to and meeting with the first end 20 and the fold edge 24, and a back panel 28 (FIG. 5) bordered by the upper lower edges 16, 18 extending to and meeting with the second end 22 and the fold edge 24.

A shaped opening 30 is provided through the overlaying face and back panels 26, 28 proximate the upper edge 16. The opening 30 is used for hanging the package on a display rack at the point of sale.

The face panel 26 is provided with a window opening 32 so that a prospective purchaser can view the compact disc 14 contained inside the package 10. The window 32 has a shape similar to that of the compact disc 14 and comprises spaced apart upper and lower window edges 34 and 36 extending to and meeting with left and right curved window edges 38 and 40. The upper and lower window edges 34, 35 are paralleled to the upper and lower edges 16, 18 of the envelope 12. The window 32 is centered between the first end 20 of the face panel 26 and the fold edge 24.

A sheet 42 of transparent polymeric material is secured to the back side of the face panel 26 to cover the window 32. Preferably the sheet 42 is secured thereto by an adhesive.

The compact disc 14 has a shape somewhat similar to that of the window 32, but only of a smaller peripheral size. In that respect, the compact disc 14 comprises upper and lower straight edges 44 and 46 extending to and meeting with left and right curved edges 48 and 50. A circular opening 50 is provided in the compact disc 14 surrounded by a circular groove 52. Both the opening 50 and the groove 52 are coaxially aligned and centered between the upper and lower straight edges 44, 46 and centered between the left and right curved edges 48, 50. The shape of the compact disc is designed to be easily carried in the user's wallet and the like.

Inside the package 10, the compact disc 14 is generally centered in the window 32. In that position, a front side 54 of the compact disc 14 is provided with instructional and promotional text (not shown) and a bar code 56 which can be viewed by the purchaser and the sales associate. If desired, the bar code can be replaced by a magnetic strip (not shown), or a magnetic strip can be used in conjunction with the bar code. The back side 58 of the compact disc 14 is provided with computer readable information (not shown), which is programmed for allowing access to the internet. A PIN embedded in the computer readable information is activated at the time of card activation to allow access to an internet web site. A removable adhesive 60 serves to secure the back side 58 of the compact disc 14 to the back panel 28.

After the compact disc 14 is positioned between the face and back panels 26, 28, the overlapping edges of the envelope 12 are secured to each other. In that respect, the two halves of the upper and lower edges 16, 18 bisected by the fold edge 24 are secured to each other, such as by an adhesive 62. Similarly, the coinciding first and second ends 20, 22 of the card stock are secured to each other, such as by adhesive 62.

The back panel 28 is provided with instructional and promotional text (not shown) and a computer readable bar code 64. The bar code 64 is preferably used for tracking inventory of the prepared internet CD packages 10.

The package 10 has coinciding perforation lines 66 and 68 in the respective face and back panels 26, 28. Both perforation lines 66, 68 run from the upper edge 16 to the lower edge 18, and are spaced from the coinciding first and second ends 20, 22 and from the right curved edge 40 of the window 32.

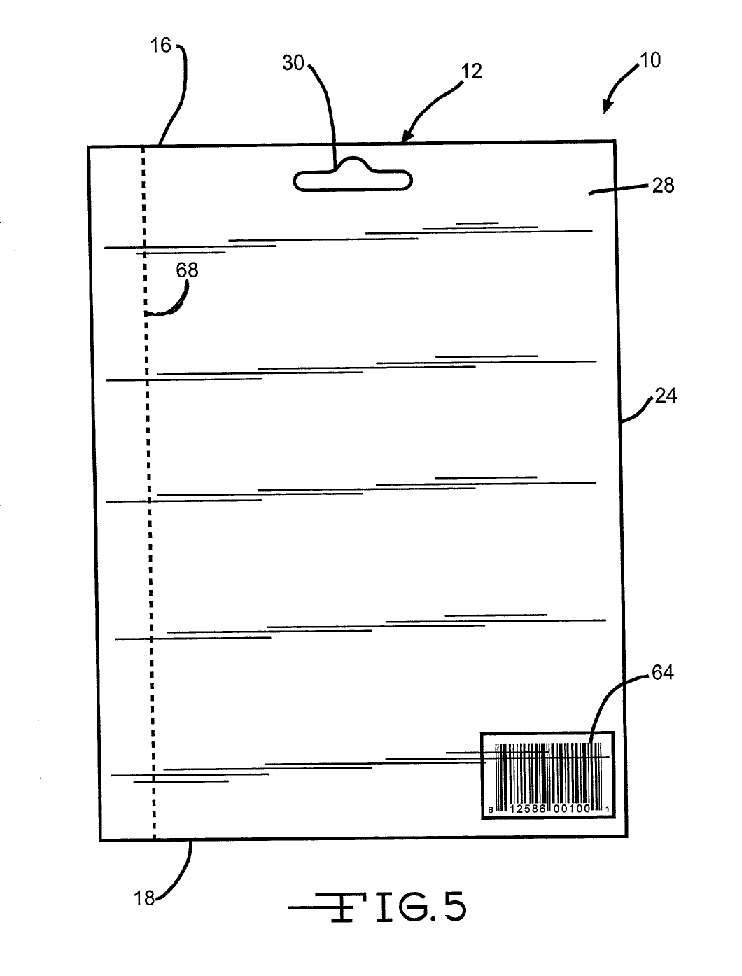

As shown in FIG. 4, the compact disc 14 is removed from the envelope 12 by folding the overlapping face and back panels 26, 28 along the coinciding perforation lines 66, 68. The resulting selvage strip 70 is torn off along the perforations 66, 68 and discarded in the proper manner. The compact disc 14 is now able to be removed from the envelope 12 for loading into a computer (now shown).

In use, the bar code 56, or a magnetic strip if there is one, is used for selectively activating the compact disc 14 at the manufacturer or at the point-of-sale. The activated compact disc 14 is then used for accessing the internet and, if desired, downloading music and/or other electronic information from a web site onto a separate information storage device (not shown), such as a CD burner, a diskette, a tape, MP3 player, and the like. In that respect, after the activated compact disc 14 is loaded into a CD-ROM tray of a computer, the user simply waits for the start menu to appear on the video monitor and clicks on the connect icon to access the internet. The compact disc 14 then provides measured access to the internet or to a restricted web site for a defined period of time, typically measured in minutes, or until a prepaid number of measured digital files are downloaded. In the latter case, the user may be on the internet as long as they want, but they are only charged for actual downloads. If digital downloads are the unit of measure, the system can be constructed so that the user is limited to one web site, or a grouping of web sites.

The downloaded files may be measured in dollars or file downloads as purchase decrements from the original or remaining monetary balance or file download credits on the purchase price of the package 10 or from a separate account. In another embodiment, additional value can be added to the compact disc 14 using a credit card, debt card, checking account, and the like, or payment for internet access and downloads is from a separate account.

Thus, it can be seen that the present invention is directed to a package 10 intended to be sold at retail to a person desiring to access the internet and, if desired, download music and other data files from a web site. The package includes a compact disc 14 which is selectively activatable and then loaded into a machine electronically connected to the internet. The compact disc 14 is activated at the manufacturer and shipped live, or at the point of sale, by scanning a bar code on the disc. If the compact disc is shipped live, its receipt must be verified by the retailer to maintain activation. Internet access can simply be for browsing for a period of time or for the purpose of downloading information files to a separate data capture device, such as the user's hard drive. The compact disc can also be a value instrument, or the user can have monetary credits at a separate account. The compact disc preferably enables additional money or download credits to be added, as desired.

While the preferred embodiment of the present invention has been disclosed, it will be appreciated that it is not limited thereto, but may be embodied within the scope of the following claims.

What is claimed is:

1. A package, which comprises:
a) a face panel;
b) a back panel; and
c) a compact disc disposed at an intermediate position between the face panel secured to the back panel providing an envelope for the compact disc.

2. The package of claim 1 wherein the face panel and the back panel are secured to each other about their coinciding peripheries.

3. The package of claim 1 wherein the face panel and the back panel are of a unitary piece of card stock folded along a fold edge.

4. The package of claim 3 wherein the face panel and the back panel are adhesively secured to each other about their coinciding peripheries except at the fold edge.

5. The package of claim 1 wherein the face panel comprises upper and lower face edges extending to and meeting with first and second face ends and wherein the back panel comprises upper and lower back edges extending to and meeting with third and fourth back ends, and wherein the face panel is secured to the back panel having the upper and lower face edges aligned with the upper and lower back edges and with the first and third ends and the second and fourth ends of the respective face and back panels aligned.

6. The package of claim 1 wherein an opening is provided through the face and back panels for hanging the package on a display device.

7. The package of claim 1 wherein the face panel has a window for viewing at least a portion of the compact disc.

8. The package of claim 7 wherein a transparent sheet of polymeric material covers the window, disposed intermediate the face panel and the compact disc.

9. The package of claim 7 wherein the compact disc includes an activation device which is viewable through the window.

10. The package of claim 9 wherein the activation device is either a bar code or a magnetic strip.

11. The package of claim 7 wherein the window has a shape similar to that of the compact disc.

12. The package of claim 1 wherein the compact disc is shaped to fit into a wallet.

13. The package of claim 1 wherein the compact disc has spaced apart first and second straight edges extending to and meeting with opposed curved edges.

14. The package of claim 5 wherein the face and back panels contain respective coinciding first and second perforation lines to provide a removable selvage edge for accessing the compact disc inside the envelope.

15. A method for accessing the internet, comprising the steps of:
a) providing a package comprising a face panel, a back panel, and a compact disc disposed at an intermediate position between the face panel secured to the back panel providing an envelope for the compact disc, wherein the face panel includes a window for viewing an activation device on the compact disc;
b) activating the activation device on the compact disc;
c) removing the compact disc from the package; and
d) using the compact disc to access the internet.

16. The method of claim 15 including providing the face panel and the back panel of a unitary piece of card stock folded along a fold edge.

17. The method of claim 15 including providing the face panel comprising upper and lower face edges extending to and meeting with first and second face ends and the back panel comprising upper and lower back edges extending to and meeting with third and fourth back ends and further securing the face panel to the back panel having the upper and lower face edges aligned with the upper and lower back edges and with the first and third ends and the second and fourth ends of the respective face and back panels aligned.

18. The method of claim 17 including providing a first line of perforations in the face panel extending from the upper face edge to the lower face edge and a second line of perforations in the back panel extending from the upper back edge to the lower back edge and wherein the first and second perforation lines coincide to provide a removable selvage edge for accessing the compact disc inside the envelope.

19. The method of claim 15 including providing the activation device as either a bar code or a magnetic strip.

20. The method of claim 15 including using the compact disc to download a data file from the internet onto a data storage device.
